(19) United States
(12) Patent Application Publication
(10) Pub. No.: US 2015/0195594 A1
(43) Pub. Date: Jul. 9, 2015

(54) Systems and Methods for Authenticating a User to Access Multimedia Content

(71) Applicant: VIACOM INTERNATIONAL INC., New York, NY (US)

(72) Inventors: Kimberly HICKS, New York, NY (US); Diana GERMAN, New York, NY (US)

(73) Assignee: VIACOM INTERNATIONAL INC., New York, NY (US)

(21) Appl. No.: 14/149,367

(22) Filed: Jan. 7, 2014

(51) Int. Cl. H04N 21/258; H04N 21/643; H04N 21/6377; H04N 21/239

(52) U.S. Cl. CPC H04N 21/25875; H04N 21/25816; H04N 21/2396; H04N 21/64322; H04N 21/6377

(57) ABSTRACT

Described herein are systems and methods for authenticating a user to access multimedia content, such as video content, over a user device. A method may comprise receiving a user request for a multimedia content service from a user device over a first application, receiving an identifier of the user device, identifying a service provider of a user, generating an activation code associating the identifier with the service provider, transmitting the activation code to the first application on the user device, receiving the activation code from the user over a second application, activating the multimedia content service for the user device based on the user activation input, and providing content from the multimedia content service to the user device over the first application.

### BACKGROUND

Streaming media is multimedia content that is constantly received by and presented to an end-user while being delivered by a provider. The streaming of media, either live or recorded, typically utilizes an encoder to digitize the content, a media publisher, and a content delivery network to distribute and deliver the content. Advances in computer networking, combined with powerful home computers and modern operating systems, has made streaming media practical and affordable for ordinary consumers. One form of streaming media includes the digital distribution of television content via the Internet. Internet television is a general term that covers the delivery of television shows and other video content over the Internet by video streaming technology, typically by major traditional television broadcasters.

Internet Protocol television (“IPTV”) is a system through which television services are delivered using the Internet protocol suite over a packet-switched network such as the Internet, instead of being delivered through traditional terrestrial, satellite signal, and cable television formats. Examples of IPTV service types may include live television including interactivity related to the current TV show, time-shifted television (e.g., replays a TV show that was broadcast hours or days ago) and video on demand (“VOD”) services that allow users to select and watch video content on demand on devices including web-enabled televisions, digital media receivers, personal media devices, gaming consoles, etc.

### SUMMARY

Described herein are systems and methods for authenticating a user to access multimedia content, such as video content, over a user device. A method may comprise receiving a user request for a multimedia content service from a user device over a first application, receiving an identifier of the user device, identifying a service provider of a user, generating an activation code associating the identifier with the service provider, transmitting the activation code to the first application on the user device, receiving the activation code from the user over a second application, activating the multimedia content service for the user device based on the user activation input, and providing content from the multimedia content service to the user device over the first application.

Further described herein is a non-transitory computer readable storage medium with an executable program stored thereon, wherein the program instructs a processor to perform actions that include receiving a user request for video content from a user device, identifying a user identifier of the user, identifying a service provider of the user, generating an activation code associated with the user identifier and the service provider, receiving user activation input from the user, validating the user activation input, the user identifier and the service provider with the activation code, and providing the video content to the user via the user device upon validation.

Further described herein is a device, comprising a memory storing a plurality of rules, and a processor coupled to the memory and configured to perform actions that include receiving a user request for a multimedia content service from a user device over a first application, receiving an identifier of the user device, identifying a service provider of a user, generating an activation code associating the identifier with the service provider, transmitting the activation code to the first application on the user device, receiving the activation code from the user over a second application, activating the multimedia content service for the user device based on the user activation input, and providing content from the multimedia content service to the user device over the first application.

### DESCRIPTION OF THE DRAWINGS

FIG. 1 shows a system for authenticating and authorizing a user to access multimedia content from a content provider over a user device according to an exemplary embodiment described herein.

FIG. 2 shows a graphical user interface (“GUI”) on the user device running an exemplary streaming media software application according to an exemplary embodiment described herein.

FIG. 3 shows a method for authenticating and authorizing a user to access multimedia content from a content provider over a user device according to an exemplary embodiment described herein.

### DETAILED DESCRIPTION

The exemplary embodiments may be further understood with reference to the following description and the appended drawings, wherein like components are referred to with the same reference numerals. The exemplary embodiments show systems and methods for authenticating a user to access multimedia content over a device, such as a web-enabled user device. For instance, an exemplary authentication server may allow for authentication of information related to a media service, such as user identification data, device identification data, content provider data, etc. Upon authenticating such information, the user may be provided with streaming media via the user's web-enabled device.

While the exemplary embodiments described herein may relate to systems and methods for authenticating a user to access multimedia content over a web-enabled gaming console, one skilled in the art will understand that the systems and methods may be implemented within any network-connected or web-enabled computing device. Web-enabled devices may be defined as any device capable of supporting web page rendering and accessing web-based content via a communication protocol, such as Hypertext Transfer Protocol (“HTTP”) or Hypertext Transfer Protocol Secure (“HTTPS”). Examples of web-enabled computing devices may include, web-enabled televisions, digital media receivers, personal computers, personal media devices, mobile phones, tablets, etc. Accordingly, a communication protocol such as HTTPS may protect any data in transit between the web enabled user device and a content provider.

According to the systems and methods described herein, the exemplary embodiments may connect a streaming media application (e.g., viewer) with an authentication flow on a web-enabled device via a registration web page, or uniform resource locator (“URL”). As will be described in greater detail below, the exemplary embodiments may generate pairings of registration URLs and registration codes. In addition, the embodiments may perform linking of the registration codes to a security assertion markup language (“SAML”) assertion. SAML may be defined as a data format for exchanging authentication and authorization information between users (e.g., an identity provider) and a service provider. Furthermore, the embodiments may provide information related to the authentication state for a user. The exemplary embodiments may utilize customizable databases to store records including SAML assertion and registration codes.

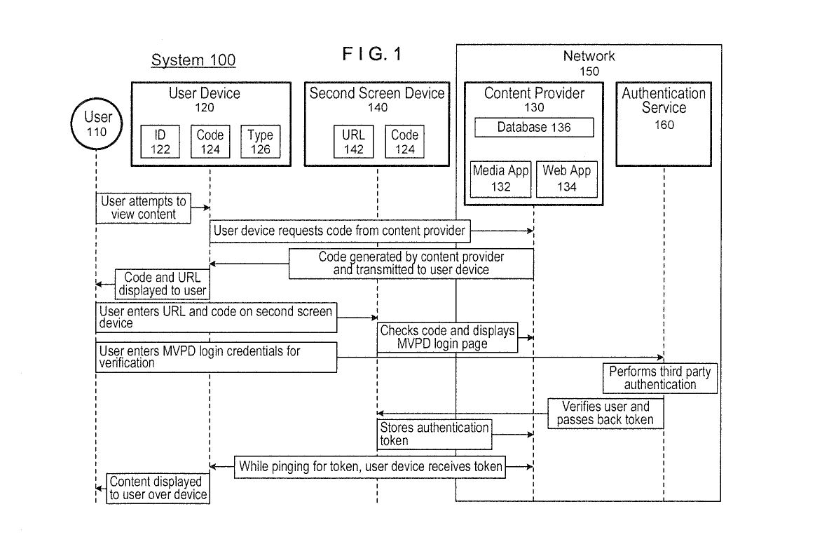

FIG. 1 shows an exemplary system 100 for authenticating and authorizing a user 110 to receive multimedia content from a content provider 130. The term authentication used herein may refer to verifying whether the user 110 has an active subscription with a particular service provider. Furthermore, the term authorization used herein may also refer to verifying whether certain media content is available to the user 110 from the service provider. It may be noted that the term service provider may include multi-channel video programming distributors (“MVPDs”) (e.g., cable television providers, satellite television providers, etc.) while the content provider 130 may refer to a source of multimedia content (e.g., television programming) that may be available from the service provider of the user 110.

According to an exemplary embodiment, the multimedia content may be in the form of a streaming media service received over a web-enabled device 120 from the content provider 130. The system 100 may further include a second user device, or “second screen” device 140, capable of accessing a network, such as via a URL on a web browsing application 142. Accordingly, both the user device 120 and the second screen device 140 may be connected to the content provider 130 via a network, such as the Internet 150.

As noted above, examples of the device 120 may include network-connected gaming consoles, web-enabled televisions, digital streaming receivers, etc. For instance, the network-connected user device 120 may support any number of software applications, such as a media application implemented to request and stream media from the content provider 130. The content provider 130 may include a media application component 132 for delivering the streaming media application and a web application component 134 for authenticating the user 110 over the second screen device 140. One skilled in the art would understand that the media application component 132 may also manage and update the software application that operates on the user device 120. For instance, the software application may be available to the user 100 through various application distribution platforms, such as a “marketplace” or “app store,” configured for the device 120, which may be operated by the owner of the operating system for the device 120.

According to the exemplary embodiments of the system 100, the user device 120 may include a user ID 122, a registration code 124, a device type indicator 126, and a service provider status 128. The user ID 122 may be a unique value that represents the software application operating on the device 120 to requests access to the streaming media service. This user ID 122 may be included within each request made by the user device 120 to the service. An example of a user ID 122 may be any personal identification information associated with the user 110, such as, for example, the user's login credentials with the device 120, the user's account information, etc.

The registration code 124 may be a code delivered to the user 110 from the content provider 130 via the media application on the user device 120. The registration code 124 may be used by the user 110 to authenticate the device 120. According to one embodiment, the registration code 124 may be a unique alphanumeric code generated by the content provider 130 for each request received from the user 110. Alternatively, the registration code 124 may be in the form of an automatic identification and capture (“ADIC”) code, such as a machine-readable barcode or Quick Response (“QR”) code. Regardless of the type of code used, the content provider 130 may generate the unique registration code 124 upon receiving a request from the user 110. Furthermore, the registration code 124 may be time-sensitive (e.g., only active for 24-hours).

The device type indicator 126 may identify the specifications and parameters of the user device 120 requesting service. For instance, the device type indicator 126 may identify a brand and/or model of the device 120, a software version operating on the device 120, display settings of the device 120, etc. As will be described in great detail below, each of the groups of the user ID 122, the registration code 124, and the device type indicator 126 may be stored in a database 136 of the content provider 130.

The service provider status 128 may include data received from the user 110 via the device 120 upon prompting the user 110. By allowing the user 110 to select his/her provider information, the user 110 may be prevented from going any further with the authentication process if the user's service provider is not active. If the user 110 incorrectly selects the wrong provider, the user 110 may select a different provider via the device 120.

As will be described in greater detail below, the system 100 may utilize the user ID 122, registration code 124, device type indicator 126, and service provider status 128 to authenticate and authorize the user 110 to receive content from the service provider. If the user 110 is not authenticated, the content provider 130 may inform the user 110 via a displayed message the device 120 (e.g., on a login page) and request user credentials. If the user 110 is not authorized, the content provider 130 may inform the user 110 via the device 120 that certain content is not available to the user 110 based on the user's subscription package with the service provider.

The authentication process may also feature a token time to live (“TTL”) variable set by a distributor for the service provider status 128. One skilled in the art will understand that the TTL may refer to a technique to limit the “lifetime” of data available over a network. Accordingly, a TTL variable may be implemented as a counter or timestamp attached to or embedded in the service provider status 128. Once the predetermined event count or lifespan has elapsed, the service provider status 128 may be considered expired. For instance, the TTL for the service provider status 128 may be set to 30 days, and upon expiration, the user 110 may be requested to resubmit his/her login credentials.

The authorization process may perform multiple checks on multiple platforms at a predetermined frequency. For instance, the authorization process may check with a third party authentication service 160 each time the user 110 initiates content that requires authorizing to ensure content access. The authorization process may also check with the service provider, such as on a daily basis, to ensure that the user 110 still maintains an active account/subscription with the service provider. If the user's account with service provider is no longer active, the system 100 may log the user 110 out and provide the user 110 with a message to login once again. This may allow the user 110 to provide new login credentials (e.g., different provider information) to update the service provider status 128 of the user 110.

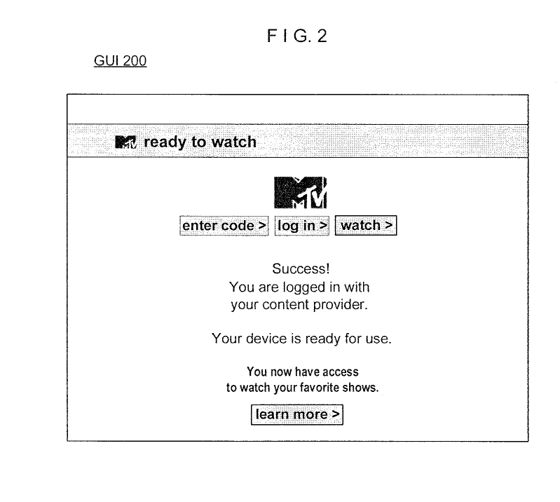

FIG. 2 shows an exemplary graphical user interface (“GUI”). 200 on the user device 120 running an exemplary streaming media software application according to an exemplary embodiment described herein. The exemplary GUI 200 depicted in FIG. 2 will be described in reference to the exemplary system 100 and its respective elements as described above with reference to FIG. 1. The streaming media software application on the device 120 may present the user 110 with access to content from the exemplary content provider 130. The GUI 200 may provide the user 110 with walk-through instructions to enter the unique registration code 124, enter login credentials, and initiate access to the requested content.

As noted above, the unique registration code 124 may be generated by the content provider 130 and stored within the database 136 of the provider 130. Furthermore, the stored unique registration code 124 may be paired with the user ID 122 of the user 110. Upon validating the pairing of the registration code 124 and the user ID 122 in the database 136, the content provider 130 may request login credentials from the user 110 via the GUI 200. The login credentials associated with the user's service provider may be authorized by the service provider or a third party authorization platform. Thus, once the user 110 has been authenticated by the code pairing and authorized by the service provider, the content provider 130 may provide the delivering content (e.g., streaming media) to the user 110 via the software application on the user device 120.

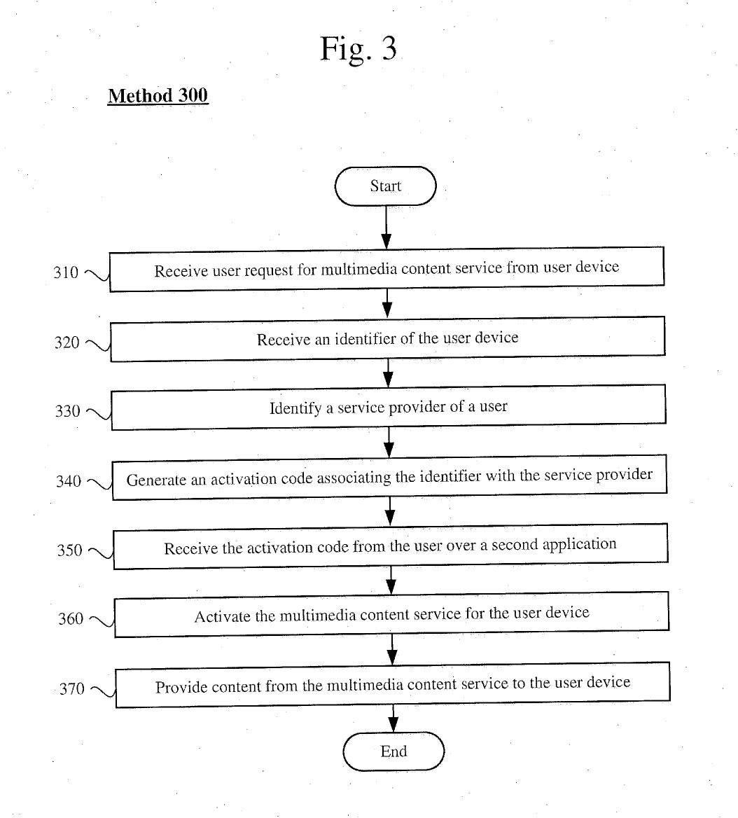

FIG. 3 shows a method 300 for authenticating and authorizing a user 100 to access multimedia content from a content provider 130 over a user device 120 according to an exemplary embodiment described herein. The steps performed by the method 300 will be described in reference to the exemplary system 100 and GUI 200 and their respective elements as described above with reference to FIGS. 1 and 2.

In step 310, the method 300 may receive a user request for video content from the user 110 via the user device 120. As noted above, the user device 120 may be a web-enabled device such as a gaming console, a web-enabled television, a digital streaming media receiver, a tablet, a personal computer, etc. Using this device 120 the user 100 provides the content provider 130 with the user request by logging into a software application operating on the device 120. Alternatively, the user 110 may provide a user request simply by requesting content from the content provider 130. For instance, the user 110 may be interested in a particular video displayed on the user device 120. By selecting the video for playback, the user 110 may be automatically prompted to enter login credentials. Thus, the user request may be in the form of selecting a login function or submitting a request for specific content. Once the user 110 has provided the user request for content, the device 120 may display an instructional screen to explain the authentication process.

In step 320, the method 300 may identify a user ID 122 of the user 110. As noted above, the user ID 122 may be a unique value that represents the software application operating on the user device 120 to requests access to the streaming media service. It should be noted that the step 320 may be performed automatically by the content provider 130. For instance, the user 110 may have already provided the user device 122 with any login credentials (e.g., account information). Accordingly, the content provider 130 may retrieve this login information without any further user interactions.

In step 330, the method 300 may identify a service provider (e.g., MVPD) of the user 110. For instance, the software application operating on the device 120 may display a list of service providers and prompt the user to select his/her provider. According to the exemplary embodiments, the list of active service providers, and associated names, logos, etc., may be maintained and managed by, the content provider 130. Once the user 110 selects the appropriate service provider, the device 120 may communicate the selected service provider information with user ID 122 to the content provider 130.

In step 340, the method 300 may generate an activation or registration code 124 associated with the user ID 122 and the service provider information. This registration code 124 may be transmitted back to the user 110 via the user device 120. In addition, the user 110 may be provided with an activation web address (e.g., activation URL) for entering the registration code 124. Alternatively, the generated registration code 124 may be a machine-readable code, such as a unique QR code. Within this embodiment, the user 110 may read the registration code 124 using personal imaging device, such as a mobile telephone operating a QR code reader or barcode scanner. The QR coded registration code 124 may automatically direct the user 110 the proper activation URL, and/or automatically validate the pairing of the user ID 122 with the registration code 124.

In step 350, the method 300 may receive user activation input from the user 110. As noted above, the user activation input may be in the form of an alphanumeric code entered into a specific activation URL onto the second screen device 140 (e.g., personal computer, mobile telephone) capable of accessing the URL on the web browsing application 142. Alternatively, in the case of a QR coded registration code 124, the user activation input may be automatically provided simply by the user 110 scanning the QR code and being directed to an activation site via the second screen device 140 (e.g., mobile web browser).

In step 360, the method 300 may activate the multimedia content service for the user device based on the user activation input. Specifically, the content provider 130 may validate that the registration code 124 is still active. The content provider may further validate that the active registration code 124 is associated with the received user ID 122. Finally, the content provider 130 may validate the user 110 has a verified and active account with the service provider.

According to one embodiment, the content provider 130 may provide the user ID 122 and selected service provider to an authentication server. The content provider 130 may instruct the user 110 that he/she is being directed to the authentication server and to verify the user's service provider status 128 with the service provider. Once the authentication server validates the user credentials, the content provider 130 may be notified that the service provider status 128 for the user 110 is valid. The content provider 130 may then display a success message to the user 110 via the user device 120.

In step 370, the method 300 may provide the video content to the user 100 via the user device 120 upon validation. Accordingly, the exemplary method 300 may enable the user 110, as service subscribers, to easily access multimedia content from any network-connected user device 120. Furthermore, the exemplary method 300 allows for content provider 130 to deliver broad range of multimedia content across to a greater number of users 110 over any number of platforms while ensuring a secure user experience.

Those of skill in the art will understand that the above-described exemplary embodiments may be implemented in any number of matters, including as a software application, as a software program, etc. For example, the exemplary method 300 may be embodied in a program stored in a non-transitory storage medium and containing lines of code that, when compiled, may be executed by a processor (e.g., a processor of the user device 120). Furthermore, one skilled in the art will understand that the exemplary software application may be coded in any computer readable language, such as, for example, a markup language (e.g., HTML5, etc.).

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving a user request for a multimedia content service from a user device over a first application;
receiving an identifier of the user device;
identifying a service provider of a user;
generating an activation code associating the identifier with the service provider;
transmitting the activation code to the first application on the user device;
receiving the activation code from the user over a second application;
activating the multimedia content service for the user device based on the user activation input; and
providing content from the multimedia content service to the user device over the first application.

2. The method of claim 1, wherein the second application is operating on a second user device connected to the multimedia content service.

3. The method of claim 1, further comprising:
authenticating the user as a subscriber to the service provider; and
authorizing the user to receive the content from the multimedia content service.

4. The method of claim 3, further comprising:
receiving a further user request for the multimedia content service from the user device; and
providing content from the multimedia content service to the user device without re-authenticating and re-authorizing the user.

5. The method of claim 1, wherein the activation code associating the identifier with the service provider is included within an automatic identification and capture (“ADIC”) code.

6. The method of claim 5, further comprising:
directing the second application to a network address encoded within the ADIC code, wherein the activation code within the ADIC code is received via the network address.

7. The method of claim 1, further comprising:
receiving a device type indicator describing at least one parameter of the user device; and
formatting the content from the multimedia content service based on the at least one parameter of the user device.

8. The method of claim 1, wherein the content from the multimedia content service is streaming video content.

9. A non-transitory computer readable storage medium with an executable program stored thereon, wherein the program instructs a processor to perform actions that include:
receiving a user request for a multimedia content service from a user device over a first application;
receiving an identifier of the user device;
identifying a service provider of a user;
generating an activation code associating the identifier with the service provider;
transmitting the activation code to the first application on the user device;
receiving the activation code from the user over a second application;
activating the multimedia content service for the user device based on the user activation input; and
providing content from the multimedia content service to the user device over the first application.

10. The non-transitory computer readable storage medium of claim 9, wherein the second application is operating on a second user device connected to the multimedia content service.

11. The non-transitory computer readable storage medium of claim 10, wherein the actions further include:
authenticating the user as a subscriber to the service provider; and
authorizing the user to receive the content from the multimedia content service.

12. The non-transitory computer readable storage medium of claim 9, wherein the actions further include:
receiving a further user request for, the multimedia content service from the user device; and
providing content from the multimedia content service to the user device without re-authenticating and re-authorizing the user.

13. The non-transitory computer readable storage medium of claim 9, wherein the activation code associating the identifier with the service provider is included within an automatic identification and capture (“ADIC”) code.

14. The non-transitory computer readable storage medium of claim 13, wherein the actions further:
directing the second application to a network address encoded within the ADIC code; wherein the activation code within the ADIC code is received via the network address.

15. The non-transitory computer readable storage medium of claim 9, wherein the actions further include:
receiving a device type indicator describing at least one parameter of the user device; and
formatting the content from the multimedia content service based on the at least one parameter of the user device.

16. A device, comprising:
a memory storing a plurality of rules; and
a processor coupled to the memory and configured to perform actions that include:
receiving a user request for a multimedia content service from a user device over a first application;
receiving an identifier of the user device;
identifying a service provider of a user;
generating an activation code associating the identifier with the service provider;
transmitting the activation code to the first application on the user device;
receiving the activation code from the user over a second application;
activating the multimedia content service for the user device based on the user activation input; and
providing content from the multimedia content service to the user device over the first application.

17. The device of claim 16, wherein the second application is operating on a second user device connected to the multimedia content service.

18. The device of claim 16, wherein the processor is further configured to perform:
authenticating the user as a subscriber to the service provider; and
authorizing the user to receive the content from the multimedia content service.

19. The device of claim 18, wherein the processor is further configured to perform:
receiving a further user request for the multimedia content service from the user device; and
providing content from the multimedia content service to the user device without re-authenticating and re-authorizing the user.

20. The device of claim 16, wherein the activation code associating the identifier with the service provider is included within an automatic identification and capture (“ADIC”) code.
